(19) United States
(12) Patent Application Publication
(10) Pub. No.: US 2008/0228400 A1
(43) Pub. Date: Sep. 18, 2008

(54) Highway safety system and method

(76) Inventor: Jeffrey D. Wheeler, Dana Point, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/725,013

(22) Filed: Mar. 15, 2007

(51) Int. Cl. G08G 1/16

(52) U.S. Cl. 701/301

(57) ABSTRACT

There is provided a highway safety system for use by a vehicle for detecting a lane boundary defined by a plurality of markers, wherein each of the plurality of markers has an associated identifier. The highway safety system comprises a detection module configured to detect the associated identifier in each of the plurality of markers defining the lane boundary, wherein the detection module is further configured to receive marker detection data from the associated identifier in each of the plurality of markers defining the lane boundary. The highway safety system further comprises an alarm module for determining an alarm condition based on marker detection data provided by the detection module, wherein the alarm module is configured to generate an alert according to the alarm condition. For example, each of the plurality of markers may be a raised pavement marker, and the associated identifier may be an RFID tag.

### BACKGROUND OF THE INVENTION

1. Field ofthe Invention

The present invention relates generally to highway safety for vehicles. More particularly, the present invention relates to the prevention of traffic accidents.

2. Background Art

Recent studies have shown that, in the past century, American adults have reduced their nightly sleep time by approximately 20%. In addition, since 1969, adults have added 158 hours a year to their working and commuting time. Adults are now getting one hour less sleep per night than what is recommended and only one half of all adults are even satisfied with the amount of sleep that they are currently getting. More than 25% of adults state that they are sleepy at work two days per week or more and approximately 10% of adults state that they occasionally or frequently fall asleep at work. Furthermore, one out of five adults state they make errors at work due to sleepiness. Many adults have expressed that on-the-job sleepiness impairs their concentration, lowers productivity, and degrades work quality.

Drowsiness creates a particular danger for vehicle operators late at night. For example, it has been shown that people are most likely to suffer unintentional sleep episodes between the hours of 12:00 a.m. to 8:00 a.m. Such unintentional sleep episodes partially explain why traffic accident rates are often higher at night. Night workers are more likely to make a variety of performance errors than day workers due to drowsiness. Alertness and performance are clearly influenced by the time of day. For example, since fatigue is a function of the number of hours a person has stayed awake and the time of day, a person is typically least alert late at night. Statistics indicate that drowsiness causes 100,000 accidents, 1,500 fatalities, and 71,000 injuries annually, and costs the United States approximately $12.5 billion a year. Driver drowsiness has reached alarming proportions. For example, 62% of the general public has reported driving drowsy in the past year and 27% have reported actually falling asleep while driving.

Fatigue is also a major problem for persons operating vehicles on highways. For example, tour bus crashes in 1998 and 1999 focused attention on hours-of-service regulations for drivers. Insufficient rest is thought to be primarily responsible for driver errors. Fatigue was noted to be one of the top ten transportation safety issues due to trucker crashes and 31% of all trucker fatalities have been shown to be fatigue related.

Unfortunately, vehicle crash statistics seriously underestimate the problem. For instance, only half of all vehicle crashes are reported and those that are self-reported tend to be inaccurate. Moreover, most law enforcement officials are not trained to detect driver fatigue and there is no objective measurement, e.g., a blood test, to detect a level of driver fatigue. Often times, driver fatigue is linked to other factors, such as alcohol or drugs. Six states do not even have fatigue codes for the prevention of fatigue related traffic accidents.

Characteristics of vehicle crashes that are caused by drowsy drivers include crashes where a single vehicle drifts off the road and hits a stationary object without any evidence of braking or evasive maneuvers. Most of such accidents occur during a dip in the human circadian rhythm, e.g., between the hours of 12:00 a.m. and 6:00 a.m. and in the mid-afternoon. The driver of a vehicle in a crash resulting from drowsy driving is typically one driving alone and is more likely to be male. Most crashes are rear-end or head-on collisions and many of the crashes involve serious injuries and/or fatalities.

Thus, there is a strong need in the art for a system and method that prevents traffic accidents caused by drowsy or weary drivers.

### SUMMARY OF THE INVENTION

There is provided highway safety systems and methods, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIGS. 1A and 1B show block diagrams of a highway safety system for use by a vehicle for detecting a highway lane boundary to prevent inadvertent drifting across the highway lane boundary in accordance with one embodiment of the invention;

FIGS. 2A and 2B illustrate an example implementation of a highway safety system in accordance with one embodiment of the invention;

FIGS. 3A and 3B illustrate example locations where a sensing device can be located on a vehicle in accordance with one embodiment of the invention; and

FIG. 4 shows a flowchart of a method for detecting a highway lane boundary to prevent a vehicle from inadvertently crossing the highway lane boundary in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

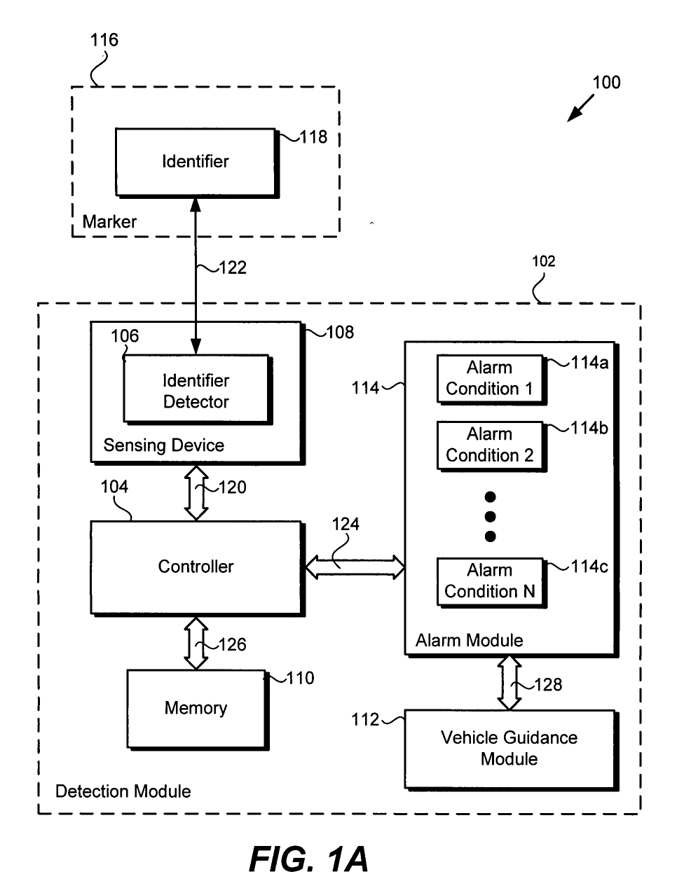

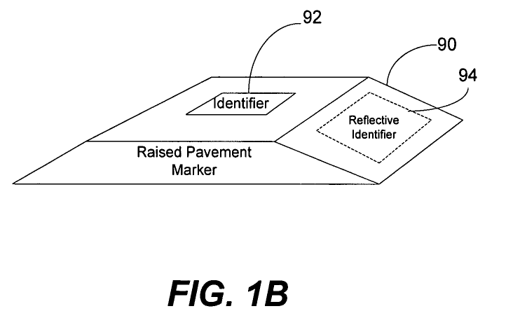

FIG. 1A shows a block diagram of a highway safety system for use by a vehicle for detecting a highway lane boundary to prevent inadvertent drifting across the highway lane boundary. As shown in FIG. 1A, system 100 includes detection module 102 and marker 116. As also shown in FIG. 1A, detection module 102 includes controller 104, alarm module 114, memory 110, vehicle guidance module 112, and sensing device 108, which includes identifier detector 106. As further shown in FIG. 1A, marker 116 includes an associated identifier 118, which can be, for instance, embedded, formed, incorporated into, or attached to the marker 116.

For example, marker 116 in FIG. 1A can be a raised pavement marker, which is typically placed on highways to delineate a lane boundary. The earliest origination of such raised pavement markers has been attributed to a man named Elbert Botts, hence these markers are often referred to as “Botts' Dots.” Current highway systems include millions of such raised pavement markers, which are usually in the shape of a raised dome and which are constructed using various materials, such as plastic, ceramic, or polyester. FIG. 1B shows one such configuration, or example. The raised pavement marker 90 is shown to include an associated identifier 92, which can be, for instance, physically embedded, incorporated, or formed into, or attached to the marker 90. Alternatively, the associated identifier 92 might be attached or affixed to an already formed marker 90. In this manner, already formed markers (or other objects) might be retroactively fitted, with the attachment of an associated identifier, to work with the present system.

In another embodiment, marker 116 can be a painted line, or a segment of a painted line, on a highway or related object. In this embodiment, the associated identifier would be physically incorporated in the paint itself, and thereby easily applied to any surface (for later detection).

In such embodiments, the functional component that should be incorporated, or associated, with the marker is an identifier tag or device that can be readily detected (or read) by another passing device. One such identifier would include an RFID tag. An RFID tag is a device including an antenna and an integrated circuit, which enables the RFID tag to receive incoming radio frequency signals from an RFID reader and to transmit a signal, i.e., a response, back to the RFID reader using techniques known in the art. As such, one or more small Radio Frequency Identification (RFID) tags can be integrated into (or attached to) the Botts' dots, or the paint used in painting the line, or the like. Identifier 118, which is included or associated with marker 116, as discussed below, may be used by detection module 102 for detecting marker 116. For example, identifier 118 can be situated inside, or attached to, marker 116.

In other embodiments, identifier 118 may be a physical property of marker 116 itself. For example, identifier 118 can be the reflective surface of a raised pavement marker. In one embodiment shown in FIG. 1A, marker 116 may include a reflective surface and/or an RFID tag. Similarly in FIG. 1B, marker 90 is shown as having an identifier 92, such as an RFID tag, and/or a reflective surface identifier 94.

The RFID tag can be an active RFID tag, which might include an RFID tag having its own power supply (e.g., a battery, or solar cell, or the like), and which can be configured to receive, store, and transmit data, such as an identification number. In other embodiments, the RFID tag can be a passive RFID tag, which might include an RFID tag that does not have its own power supply, and which can be configured to receive, store, and transmit data.

Detection module 102 in FIG. 1A is an electronic device that can be configured to detect identifier 118 in marker 116. As shown in FIG. 1A, sensing device 108, alarm module 114, and memory 110 in detection module 102 are in communication with controller 104 via data paths 120, 124, and 126, respectively. Controller 104 can be, for example, a combinatorial logic circuit or a microcontroller, or any other type of controller. For example, embedded identifier detector 106 in sensing device 108 can be an RFID reader that can establish communication link 122 with identifier 118, which can be an RFID tag as discussed above. Thus, in one embodiment, communication link 122 can be established using radio frequency signals. For example, communication link 122 can be established when identifier 118 receives adequate incoming radio frequency signals from identifier detector 106, thereby enabling identifier 118 to transmit a signal back to identifier detector 106.

In another embodiment, identifier detector 106 can include a reflective optical sensor that includes an infrared emitter and a phototransistor receiver. In still other embodiments, sensing device 108 can include additional identifier detectors suitable for detecting various identifiers that might be included in marker 116.

When sensing device 108 is situated within a suitable distance of marker 116, a communication link, e.g., communication link 122, can be established between identifier 118 and identifier detector 106 in sensing device 108. In one embodiment, identifier 118 can be configured to transmit data stored in identifier 118 to the identifier detector 106. For example, the data can include an identification number associated with marker 116. As another example, when sensing device 108 is situated within a suitable distance of marker 116, identifier detector 106 can be configured to detect marker 116 by emitting infrared light at marker 116 and detecting the infrared light reflected off the reflective surface of marker 116. This embodiment is not limited to infrared light, but is meant to include other ranges too.

As shown in FIG. 1A, sensing device 108 can provide marker detection data indicating the detection of a marker to controller 104 via data path 120. Data path 120, for example, can be a physical connection, such as a bus, or a wireless connection established using radio frequency signals. Controller 104 can be configured to immediately provide the marker detection data to alarm module 114, which can be implemented in software or hardware. As shown in FIG. 1A, alarm module 114 includes various alarm conditions 114a, 114b, and 114c. As will be discussed below, alarm module 114 can be configured to determine the proper alarm condition, i.e., alarm condition 114a, 114b, or 114c, based on the number of markers detected by sensing device 108 within a period of time. Thus, in one embodiment shown in FIG. 1A, alarm conditions 114a and 114b represent the first and second possible alarm conditions in alarm module 114, respectively, while alarm condition 114c represents the nth alarm condition. One or many alarm conditions can therefore be used, according to the desired configuration.

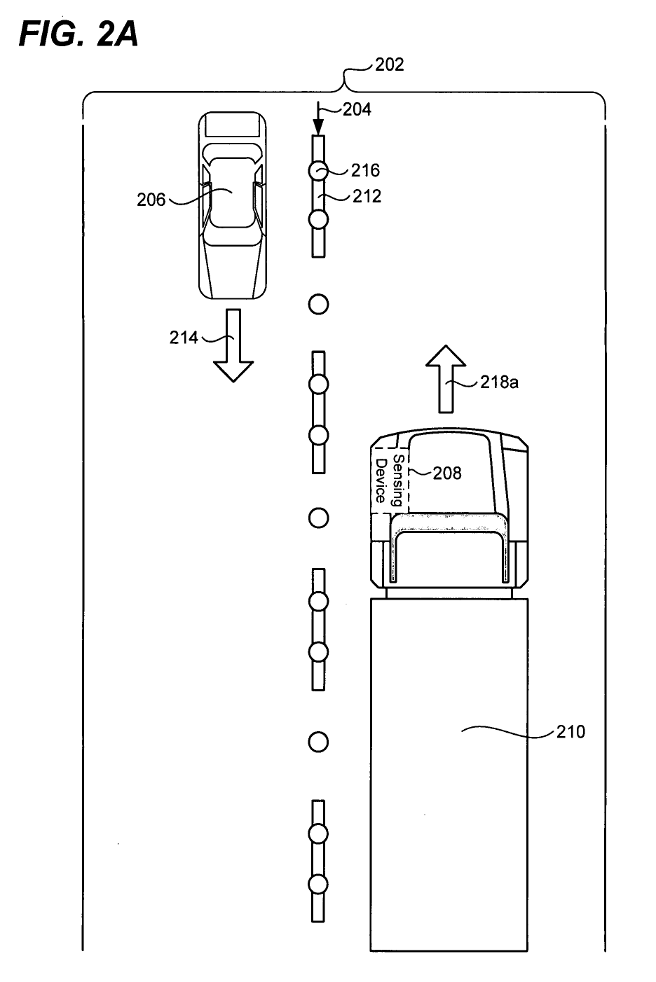

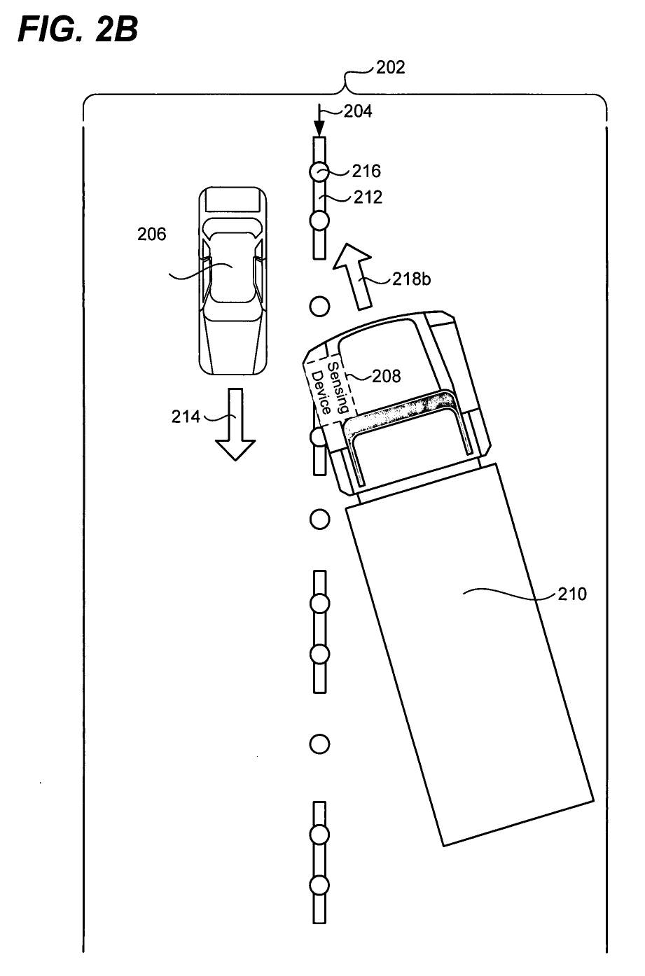

FIGS. 2A and 2B illustrate an example implementation of system 100 shown in FIGS. 1A and 1B in accordance with one embodiment of the invention. FIG. 2A shows a top view of a portion of highway 202, which includes lane boundary 204, vehicle 206, and vehicle 210. As shown in FIG. 2A, lane boundary 204 is defined by a number of markers, such as marker 216, and a number of painted lines, such as painted line 212. In other embodiments, lane boundary 204 may be defined using only markers, such as marker 216, or using only painted lines, such as painted line 212. As also shown in FIG. 2A, vehicle 206 is traveling in the direction indicated by arrow 214 and vehicle 210 is traveling in the direction indicated by arrow 218a. As further shown in FIG. 2A, sensing device 208 of detection module 102 is situated in vehicle 210 in a region nearest to lane boundary 204. Sensing device 208 and marker 216 shown in FIG. 2A correspond to sensing device 108 and marker 116 in FIG. 1A, respectively. Thus, in one embodiment of the invention shown in FIG. 2A, each of the markers in lane boundary 204, e.g., marker 216, can be a raised pavement marker, which includes one or more identifiers, such as identifier 118 shown in FIG. 1A, and identifier 92 shown in FIG. 1B.

Referring now to FIG. 2B, FIG. 1A, and FIG. 1B, vehicle 206 continues to travel in the direction indicated by arrow 214 while vehicle 210 begins to travel in the direction indicated by arrow 218b, thereby drifting over lane boundary 204 and towards oncoming vehicle 206. As sensing device 208 on vehicle 210 approaches the markers of lane boundary 204, sensing device 208 can sequentially detect each identifier of each marker through the included identifier detector, such as identifier detector 106, in sensing device 208. As discussed above, identifier detector 106 can be an RFID reader and the identifier, such as identifier 118 or 92, can be an RFID tag. Since an RFID tag can typically be read within a few milliseconds, the RFID reader in sensing device 208 can quickly communicate with the RFID tag in the detected marker even while vehicle 210 is traveling at high speeds. In one embodiment, each detected RFID tag of a marker can transmit data, such as identification data, which can be received by detection module 102 shown in FIG. 1A and stored in memory 110. The received data can be used to generate a log in memory 110 of the times and locations where vehicle 210 approached or crossed over a lane boundary.

Alarm module 114 included in detection module 102 (shown in FIG. 1A) can determine an alarm condition, e.g., alarm condition 114a or alarm condition 114b , based on the number of markers detected over a period of time. For example, alarm condition 114a might be defined as one marker detected over a period of one second and alarm condition 114b might be defined as two markers detected over a period of one second. Each alarm condition may be configured to activate a different warning mechanism for warning the driver of vehicle 210, so as to prevent vehicle 210 from inadvertently crossing lane boundary 204. For example, alarm condition 114a might be configured to activate a recorded voice message, thereby warning the driver of vehicle 210 to correct course, while alarm condition 114b might be configured to activate a loud sound, such as a horn or buzzer. Each warning mechanism might also include physical warning mechanisms, such as vibrations or jarring effects to the driver. An alarm condition might even be configured to disable the vehicle by, for example, shutting down the engine of vehicle 210 to force the driver to rest. The vehicle shutdown might be invoked after a number or type of lane boundary violations have been detected.

Since each alarm condition can be defined by the number of markers detected within a period of time, the sensitivity of each alarm condition can be varied to activate a suitable warning mechanism in relation to the speed of the vehicle. For example, if one marker is detected over a period of one second, then the vehicle is likely to be traveling at a low speed and thus the invention may be configured to activate a voice warning at a moderate sound level. Whereas if five markers are detected over a period of one second, then the vehicle is likely to be traveling at a high speed and thus the invention may be configured to activate a more noticeable warning, such as a loud horn with vibration effects to the driver. In one embodiment, the alarm module can be configured to disable the alarm conditions when the driver purposefully executes a maneuver that requires crossing the lane boundary.

In one embodiment of the invention, an alarm condition in alarm module 114 can be configured to activate vehicle guidance module 112 shown in FIG. 1A. For example, once it has been determined that vehicle 210 has drifted, or is about to drift across lane boundary 204, vehicle guidance module 112, which can be implemented in hardware or software, can be configured to automatically steer vehicle 210 away from lane boundary 204 and back toward a path of travel parallel to lane boundary 204, i.e., in the direction indicated by arrow 218a in FIG. 2A. In one embodiment, a suitable warning mechanism may also be activated along with vehicle guidance module 112, so as to alert the driver of vehicle 210 to retake control of vehicle 210.

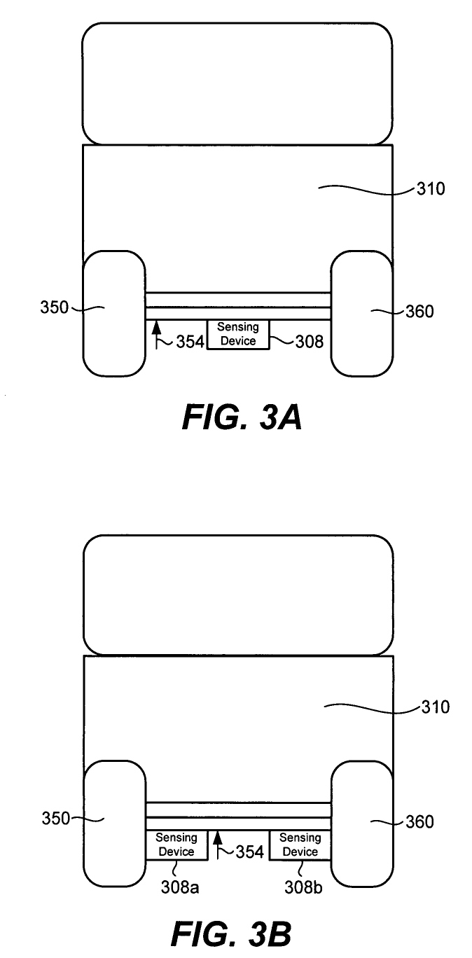

FIGS. 3A and 3B illustrate example locations where the sensing device of the invention can be located on a vehicle in accordance with one embodiment of the invention. FIG. 3A shows a rear view of vehicle 310, which includes sensing device 308. Vehicle 310 corresponds to vehicle 210 in FIGS. 2A and 2B and sensing device 308 in FIG. 3A corresponds to sensing device 108 in FIG. 1A. In one embodiment of the invention shown in FIG. 3A, sensing device 308 is located between front wheels 350 and 360, so as to be in the center of vehicle 310. As shown in FIG. 3A, sensing device 308 can be affixed to undercarriage 354 of vehicle 310 or any part of vehicle 310 where sensing device 308 can adequately sense the identifiers of the markers of a lane boundary.

FIG. 3B shows a rear view of vehicle 310, which includes sensing devices 308a and 308b. Vehicle 310 in FIG. 3B corresponds to vehicle 210 in FIGS. 2A and 2B and sensing devices 308a and 308b in FIG. 3B correspond to sensing device 108 in FIG. 1A. In the embodiment of the invention shown in FIG. 3B, sensing device 308a is located near front wheel 350 and sensing device 308b is located near front wheel 360. One or both of the sensing devices could be used at one time. As shown in FIG. 3B, sensing devices 308a and 308b can be affixed to undercarriage 354 of vehicle 310 or any part of vehicle 310 where sensing devices 308a and 308b can adequately sense the identifiers of the markers of a lane boundary, such as marker 216 in FIGS. 2A and 2B. Thus, by locating sensing devices on each side of vehicle 310, as in the embodiment shown in FIG. 3B, markers of a lane boundary on either side of vehicle 310 can be detected. Moreover, the embodiment shown in FIG. 3B ensures that markers in a lane boundary are detected before a substantial portion of vehicle 310 crosses over the lane boundary.

Sensing devices 308a and 308b can also be oriented in various directions to optimize the accuracy of sensing devices 308a and 308b. For example, sensing devices 308a and 308bcan be oriented downward, such that the respective RFID readers and/or optical sensors (and/or other type sensors) that are in sensing devices 308a and 308bwill face the highway directly below vehicle 310. In other embodiments, sensing devices 308a and 308bcan be oriented in a lateral manner to vehicle 310, thereby allowing the respective RFID readers and/or optical sensors (and/or other type sensors) that are in sensing devices 308a and 308bto detect the markers in a lane boundary even before vehicle 310 crosses over the lane boundary. In yet other embodiments, sensing devices 308a and 308bcan be configured to pivot and move, automatically or according to manual control, for dynamic or self-alignment of sensing devices 308a and 308bin relation to the target identifiers to be sensed.

The present invention can also be used to implement self-navigation by vehicle 310. For example, in the embodiment of the invention shown in FIG. 3B, vehicle 310 can be configured to use sensing devices 308a and 308bto detect the markers of lane boundaries on either side of vehicle 310. Thus, vehicle guidance module 112 in FIG. 1A can be configured to use the location of the lane boundaries determined by sensing devices 308a and 308bto accurately and safely navigate vehicle 310 between the lane boundaries. Furthermore, such an embodiment can be advantageous during, for example, snowy weather conditions where the lane boundaries cannot be seen by the driver of vehicle 310. Since, for example, sensing devices 308a and 308b can detect the markers of a lane boundary using radio frequency signals, the lane boundaries can still be detected below the snow or other debris for accurate self-navigation of vehicle 310.

The present invention can be further used to facilitate the parking of a vehicle. For example, the markers of the invention can be placed so as to define a parking space boundary. The detection module can then be used, for example, to detect the markers and to indicate to the driver when the vehicle is crossing over the parking space boundary, thereby guiding the driver in the proper parking of the vehicle.

As mentioned above, the sensing device of the present invention is not limited to the use of optical sensing techniques or RFID signaling techniques to detect the markers of a lane boundary. Accordingly, in other embodiments, sensing device 108 in FIG. 1A may be configured to detect a marker of a lane boundary using any one of a number of available wireless communication technologies, such as Bluetooth or IEEE 802.11 (i.e., the Wi-Fi standard). In such embodiments, the embedded identifier of a marker can be a low power transceievr that can be included in each of the markers defining a lane boundary of a highway. Furthermore, each marker can include a small solar cell and power storage device for powering the transceiver at nighttime. Thus, the embedded identifier of each marker can then be configured to relay data, such as traffic information, from one embedded identifier of a marker to another embedded identifer in a neighboring marker, thereby forming a data grid along a highway. The data can then be received by the sensing device of the invention and provided to the driver of vehicle 310.

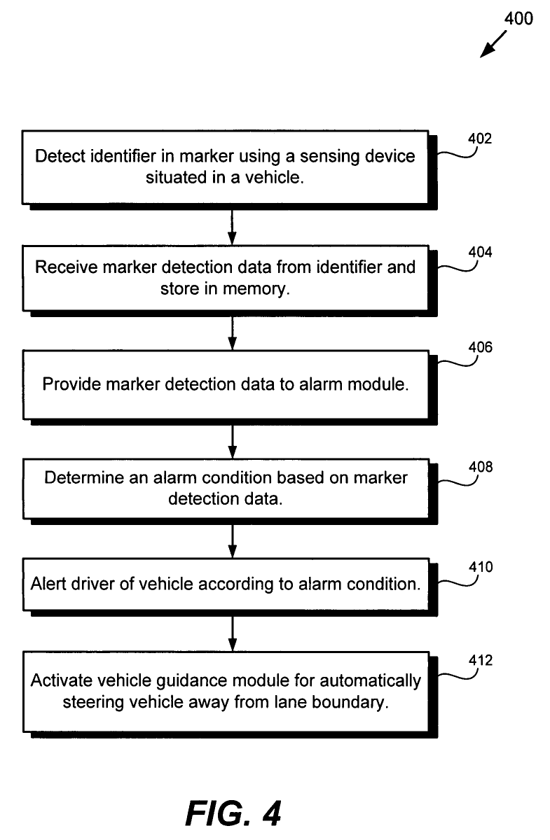

FIG. 4 shows a flowchart for performing method 400 for detecting a highway lane boundary to prevent a vehicle from inadvertently crossing the highway lane boundary in accordance with one embodiment of the invention. As shown in FIG. 4 and with reference to FIG. 1A, at step 402 of flowchart 400, the identifier included in a marker of a highway lane boundary is detected using a sensing device, e.g., sensing device 108, situated in the vehicle. At step 404 of flowchart 400, marker detection data from the identifier is received by the detection module and stored in memory. At step 406, the marker detection data in provided to an alarm module, e.g., alarm module 114. Then, at step 408, an alarm condition is determined based on the marker detection data. At step 410, an alert signal is generated and the driver of the vehicle is alerted according to the alarm condition. At step 412, a vehicle guidance module is activated for automatically steering the vehicle away from the highway lane boundary.

Thus, the present invention can be used to effectively prevent drowsy motorists, especially weary truckers driving late at night, from inadvertently crossing a lane boundary of highway and veering onto oncoming traffic, thereby saving many lives each year. Since the invention can be implemented using, for example, passive RFID tags in typical raised pavement markers used to define a lane boundary of a highway, the present invention can be implemented with relative ease and low cost. Moreover, since the sensing device of the invention can use additional sensing devices, e.g., optical sensors, to sense the reflective surfaces of raised pavement markers currently in use, the present invention can be immediately implemented using infrastructures already in place. Such additional sensing devices can also serve as backup sensing mechanisms to provide more robust and accurate sensing of the markers of a lane boundary.

The lane boundary detection features of the invention can also be used for enabling self-navigation by a vehicle. Accordingly, vehicles may be configured to operate, to some degree, in an “auto-pilot” mode for safer and more convenient hands-free driving (under certain circumstances). Furthermore, the lane boundary detection features of the invention can be particularly useful for identifying the location of a lane boundary in poor weather conditions, such as snow or fog, where visibility may be low. In addition, where the markers of a lane boundary are equipped with more advanced wireless communication technologies, such as Bluetooth or the like, valuable traffic information or other data may be communicated along a series of markers on a highway. The information can then be read or provided to a vehicle traveling on the highway. Thus, a vehicle traveling on the highway may be alerted of a traffic accident ahead, which cannot otherwise be detected, for example, when visibility may be low. This information relay system would require each marker to transmit the set of information only as far as the next marker, and would alleviate the need for data wires to run parallel to the highway.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A highway safety system for use by a vehicle for detecting a lane boundary defined by a plurality of markers, each of said plurality of markers having an associated identifier, said system comprising:
a detection module configured to detect said associated identifier in each of said plurality of markers defining said lane boundary, wherein said detection module is further configured to receive marker detection data from said associated identifier in each of said plurality of markers defining said lane boundary; and
an alarm module for determining an alarm condition based on marker detection data provided by said detection module, wherein said alarm module is configured to generate an alert according to said alarm condition.

2. The system of claim 1 wherein said associated identifier is an RFID tag.

3. The system of claim 2 wherein said detection module includes an RFID reader.

4. The system of claim 1 wherein said each of said plurality of markers is a raised pavement marker.

5. The system of claim 1 wherein said each of said plurality of markers is a painted line that includes one or more RFID tags.

6. The system of claim 1 wherein said associated identifier has a reflective surface.

7. The system of claim 1 wherein said associated identifier is an active RFID tag configured to store and transmit identification data to said detection module.

8. The system of claim 1 wherein said associated identifier is a wireless communication device, wherein said associated identifier is configured to transmit data to a neighboring associated identifier.

9. A highway safety method for use by a vehicle for detecting a lane boundary defined by a plurality of markers, each of said plurality of markers having an identifier, said highway safety method comprising:
detecting said identifier in each of said plurality of markers defining said lane boundary using a detection module situated in said vehicle;
receiving marker detection data from said identifier in each of said plurality of markers defining said lane boundary using said detection module;
providing said marker detection data to an alarm module situated in said vehicle;
determining an alarm condition based on said marker detection data; and
generating an alert according to said alarm condition.

10. The method of claim 9 wherein said identifier is an RFID tag.

11. The method of claim 10 wherein said sensing device includes an RFID reader.

12. The method of claim 9 wherein each of said plurality of markers is a raised pavement marker.

13. The method of claim 9 wherein each of said plurality of markers is a painted line that includes one or more RFID tags.

14. The method of claim 9 wherein said identifier has a reflective surface.

15. The method of claim 9 wherein said identifier is an active RFID tag configured to store and transmit identification data.

16. The method of claim 9 wherein said identifier is a wireless communication device,
wherein said identifier is configured to transmit data to a neighboring identifier.

17. A highway safety marker for use by a vehicle for detecting a defined lane boundary, said highway safety marker comprising:
an identifier associated with said highway safety marker, wherein said identifier is configured to enable a vehicle detection module in said vehicle to detect said associated identifier in said marker defining said lane boundary, and wherein said identifier is further configured to provide marker detection data from said associated identifier said marker defining said lane boundary to said vehicle, for use by said vehicle to generate an alert.

18. The marker of claim 17 wherein said marker is a raised pavement marker.

19. The marker of claim 17 wherein said identifier is an RFID tag.

20. The marker of claim 17 wherein said identifier has a reflective surface.
